(19) United States
(12) Patent Application Publication
(10) Pub. No.: US 2016/0014206 A1
(43) Pub. Date: Jan. 14, 2016

(54) COMMUNICATION ASSISTANCE APPARATUS AND COMMUNICATION SYSTEM

(71) Applicant: DENSO CORPORATION, Aichi (JP)

(72) Inventor: Norihiro ISOBE, Tokai-city (JP)

(21) Appl. No.: 14/772,745

(22) PCT Filed: Feb. 4, 2014
(86) PCT No.: PCT/JP2014/000577

§ 371 Date: Sep. 3, 2015

(30) Foreign Application Priority Data
Mar. 4, 2013 (JP) 2013-042233
May 23, 2013 (JP) 2013-108513

(51) Int. Cl. H04L 29/08; H04M 1/60; H04W 4/04

(52) U.S. Cl. CPC H04L 67/12; H04W 4/046; H04M 1/6075

(57) ABSTRACT

A communication assistance apparatus assists the communication between a mobile terminal and an in-vehicle apparatus connected to various units of a vehicle, and includes a proximity wireless interface and a retaining portion. The proximity wireless interface is connected to the in-vehicle apparatus in order to receive, by proximity high-speed wireless communication, data from the mobile terminal and transmit, by proximity high-speed wireless communication, data from the in-vehicle apparatus to the mobile terminal. The retaining portion is disposed in a vehicle compartment of the vehicle to retain the mobile terminal so as to establish proximity high-speed wireless communication between the proximity wireless interface and the mobile terminal.

### CROSS REFERENCE TO RELATED APPLICATION

The present disclosure is based on Japanese Patent Application No. 2013-42233 filed on Mar. 4, 2013 and Japanese Patent Application No. 2013-108513 filed on May 23, 2013, the disclosures of which are incorporated herein by reference.

### TECHNICAL FIELD

The present disclosure relates to a communication assistance apparatus that assists the communication between an in-vehicle controller and a mobile terminal. The present disclosure also relates to a communication system.

### BACKGROUND ART

The amount of information acquired by an in-vehicle camera or various sensors has recently increased to increase the amount of information handled by an in-vehicle information terminal. Further, user preferences are diversified so that the in-vehicle information terminal is required to offer a variety of functions. The in-vehicle information terminals are thus developed to be highly functional to match various user preferences and capable of implementing various functions by executing a variety of vehicle applications (refer to Patent Literature 1).

### PRIOR ART LITERATURES

### Patent Literature

Patent Literature 1: JP 2012-71711 A

### SUMMARY OF INVENTION

Not all functions incorporated in a highly-functional in-vehicle information terminal are required by many users. Users require limited functions that match their preferences. However, customizing the in-vehicle information terminal to suit user preferences is costly and difficult to achieve. Meanwhile, users can easily customize a mobile terminal by installing applications that suit their preferences.

This leads to an idea that incorporates the functions of the in-vehicle information terminal into the mobile terminal by allowing the mobile terminal to communicate with the in-vehicle information terminal. When the mobile terminal is brought into physical contact with an in-vehicle controller to connect them, stable communication can be established. However, if a trouble occurs at a point of connection, vehicle control may be adversely affected. When, in contrast, the in-vehicle controller is connected to many and unspecified mobile terminals by using a wireless communication method that establishes simultaneous one-to-many wireless communications or wireless connections, such as Wi-Fi (registered trademark) and Bluetooth (registered trademark), stable communication cannot be established with ease.

A main object of the present disclosure is to provide a communication assistance apparatus and a communication system that are capable of incorporating the functions of an in-vehicle information terminal into a mobile terminal by establishing stable high-speed wireless communication between the mobile terminal and an in-vehicle controller.

To achieve the above object, according to an example of the present disclosure, a communication assistance apparatus is provided as follows. The communication assistance apparatus assists communication between a mobile terminal and an in-vehicle controller connected to various units of a vehicle. The communication assistance apparatus includes a communication portion and a retaining portion. The communication portion is connected to the in-vehicle controller to receive, by proximity high-speed wireless communication, data from the mobile terminal, and to transmit, by proximity high-speed wireless communication, data from the in-vehicle controller to the mobile terminal. The retaining portion is disposed in a vehicle compartment of the vehicle to retain the mobile terminal to establish proximity high-speed wireless communication between the communication portion and the mobile terminal.

This structure enables the communication portion to receive data that is transmitted from the mobile terminal by proximity high-speed wireless communication. Further, data received from the in-vehicle controller by the communication portion is transmitted to the mobile terminal by proximity high-speed wireless communication. Proximity wireless communication is typically used by temporarily placing relevant communication units in proximity to each other. In order to continuously establish proximity wireless communication, however, the mobile terminal needs to be retained in a compartment of a moving vehicle. Thus, a retaining portion is disposed in a vehicle compartment to retain the mobile terminal so as to establish proximity high-speed wireless communication between the communication portion and the mobile terminal.

Proximity high-speed wireless communication provides wireless communication while two specific communication units are placed in proximity to each other; namely, proximity high-speed wireless communication is used to establish wireless communication only between two specific units. This can establish stable one-to-one high-speed wireless communication between the mobile terminal and the in-vehicle controller, in contrast to the use of a wireless communication method that provides simultaneous one-to-many wireless connections. Installing a vehicle application on the mobile terminal enables the in-vehicle controller to transmit data acquired by various units to the mobile terminal and enables the mobile terminal to transmit commands to the in-vehicle controller for the purpose of manipulating various units. The functions of the in-vehicle information terminal can thus be incorporated into the mobile terminal. Further, connecting wirelessly the in-vehicle controller to the mobile terminal eliminates trouble caused by a connection based on a physical contact.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an overall configuration of an in-vehicle system;

FIG. 2 is a diagram illustrating a configuration of a communication assistance apparatus, in-vehicle apparatus, and mobile terminal according to a first embodiment;

FIG. 3 is a diagram illustrating how the communication assistance apparatus is mounted on an instrument panel;

FIG. 4 is a cross-sectional view illustrating how the communication assistance apparatus is mounted on the instrument panel;

FIG. 5 is a diagram illustrating an in-vehicle display that is mounted in a recessed portion of the instrument panel;

FIG. 6 is a diagram illustrating a decorative panel that is mounted in the recessed portion of the instrument panel;

FIG. 7 is a diagram illustrating how the communication assistance apparatus is mounted on the rear surface of a driver seat or of a front passenger seat;

FIG. 8 is a cross-sectional view illustrating how the communication assistance apparatus is mounted on the rear surface of the driver seat or of the front passenger seat;

FIG. 9 is a diagram illustrating how the communication assistance apparatus is mounted on the rear surface of the driver seat or of the front passenger seat;

FIG. 10 is a cross-sectional view illustrating how the communication assistance apparatus is mounted on the rear surface of the driver seat or of the front passenger seat;

FIG. 11 is a sequence diagram illustrating processing performed when the mobile terminal is used as an in-vehicle information terminal;

FIG. 12 is a flowchart illustrating a process performed when the in-vehicle apparatus communicates with the mobile terminal;

FIG. 13 is a diagram illustrating a configuration of a communication assistance apparatus, an in-vehicle apparatus, and a mobile terminal according to a second embodiment;

FIG. 14 is a diagram illustrating how the communication assistance apparatus is mounted on a dashboard according to the second embodiment;

FIG. 15 is a cross-sectional view illustrating how the communication assistance apparatus is mounted on the instrument panel according to the second embodiment;

FIG. 16 is a diagram illustrating how the mobile terminal is mounted on the instrument panel according to an alternative embodiment;

FIG. 17 is a diagram illustrating how the mobile terminal is mounted on the rear surface of the driver seat or of the front passenger seat according to an alternative embodiment;

FIG. 18 is a diagram illustrating how the mobile terminal and a mobile terminal adapter are mounted on the instrument panel according to an alternative embodiment;

FIG. 19 is a cross-sectional view illustrating how the mobile terminal and the mobile terminal adapter are mounted on the instrument panel according to an alternative embodiment; and

FIG. 20 is a diagram illustrating how the mobile terminal and the mobile terminal adapter are mounted on the instrument panel according to an alternative embodiment.

### DESCRIPTION OF EMBODIMENTS

Embodiments of a communication assistance apparatus that assists the communication between a mobile terminal and an in-vehicle apparatus connected to various in-vehicle units will now be described with reference to the accompanying drawings. In the following description of the embodiments, elements identical with or equivalent to each other are designated by the same reference numerals and will not be redundantly described.

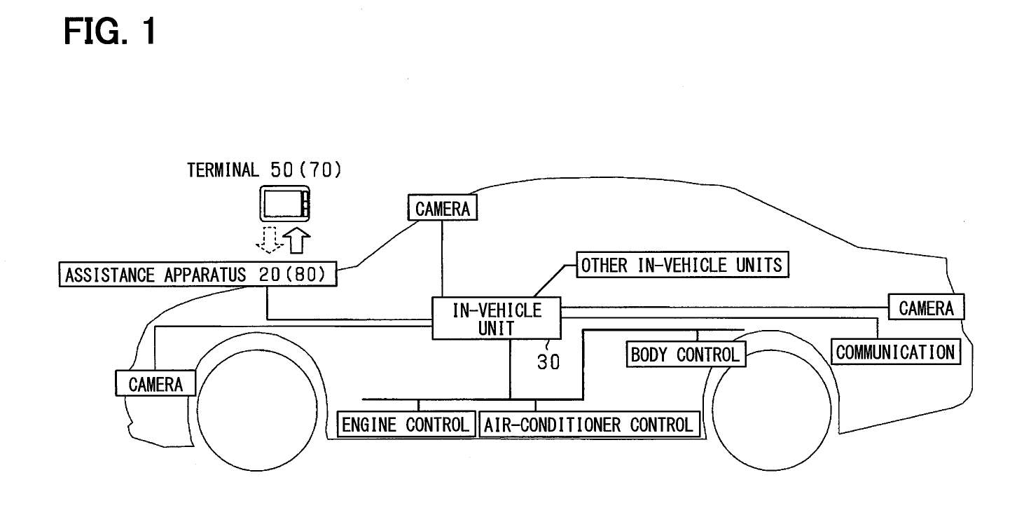

First, referring to FIG. 1, an overall configuration of an in-vehicle system according to each embodiment will be described. The in-vehicle system includes an in-vehicle apparatus 30, various in-vehicle units (various units) connected to the in-vehicle apparatus 30, a mobile terminal 50 (70), and a communication assistance apparatus 20 (80). The communication assistance apparatus 20 (80) connected to the in-vehicle apparatus 30 to establish proximity high-speed wireless communication between the in-vehicle apparatus 30 and the mobile terminal 50. A vehicle application for implementing the functions of an in-vehicle information terminal is installed on the mobile terminal 50, which is connected to the in-vehicle apparatus 30 through the communication assistance apparatus 20. The in-vehicle apparatus 30 may be referred to as an in-vehicle information control apparatus 30. The mobile terminal 50 may be referred to as a mobile information terminal 50.

The various in-vehicle units include a steering switch, a dedicated short-range communication (DSRC) unit, meters, airbags, a music playback unit, a radio, an amplifier, a loudspeaker, and a microphone, as well as an engine control unit, an air-conditioner control unit, a wireless communication unit, in-vehicle cameras, and a body control unit. The body control unit includes a light sensor, a rain sensor, a sonar, a tire pneumatic pressure sensor, a key-less entry system, and a radar.

The in-vehicle apparatus 30 receives various data, such as image data captured by the in-vehicle cameras and data detected by various sensors, from the various in-vehicle units, and transmits the received data to the mobile terminal 50 through the communication assistance apparatus 20. The mobile terminal 50 displays or stores the various data received from the communication assistance apparatus 20. Further, the mobile terminal 50 transmits control commands for the various in-vehicle units to the in-vehicle apparatus 30 through the communication assistance apparatus 20. The in-vehicle apparatus 30 transmits the received control commands to the various in-vehicle units. The various in-vehicle units execute the control commands received from the in-vehicle apparatus 30.

The in-vehicle system establishes proximity high-speed wireless communication between the mobile terminal 50 and the in-vehicle apparatus 30 as described above to incorporate the functions of an in-vehicle information terminal into the mobile terminal 50 and use the mobile terminal 50 as an in-vehicle information terminal. When, in particular, a vehicle application for implementing user-desired in-vehicle information terminal functions is installed on the mobile terminal 50, a user can customize the mobile terminal 50 to suit user preferences and use the mobile terminal 50 as a desired in-vehicle information terminal.

### First Embodiment

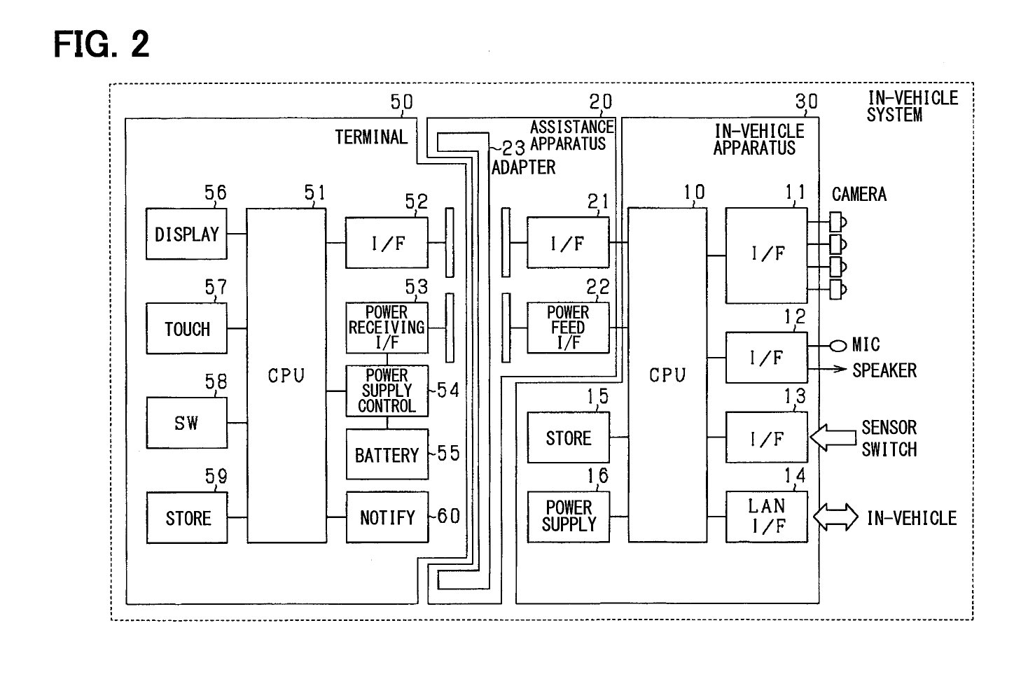

The in-vehicle system according to a first embodiment includes the communication assistance apparatus 20, the in-vehicle apparatus 30, and the mobile terminal 50. Referring to FIG. 2, the configurations of the communication assistance apparatus 20, in-vehicle apparatus 30, and mobile terminal 50 according to the first embodiment will now be described.

The in-vehicle apparatus 30 may be referred to as an in-vehicle information control apparatus 30. The in-vehicle apparatus 30 includes a CPU 10, a camera interface 11, an audio processing interface 12, an in-vehicle sensor interface 13, a vehicle LAN interface 14, a storage portion 15, and a power supply portion 16.

The CPU 10 may be referred to as an in-vehicle controller 10. The CPU 10 is connected to the various in-vehicle units through the various interfaces and also connected to the communication assistance apparatus 20. The CPU 10 controls the various in-vehicle units and exchanges data with the mobile terminal 50 through the communication assistance apparatus 20.

The camera interface 11 connects the CPU 10 to the in-vehicle cameras mounted on the front or rear of a vehicle, allows the CPU 10 to transmit control commands to the in-vehicle cameras, and permits the in-vehicle cameras to transmit image data to the CPU 10. The audio processing interface 12 connects the CPU 10 to the microphone and loudspeaker mounted on the vehicle, transmits audio data input to the microphone to the CPU 10, and allows the CPU 10 to transmit the audio data to the loudspeaker.

The in-vehicle sensor interface 13 connects the CPU 10 to the various sensors mounted on the vehicle and transmits data detected by the sensors from the sensors to the CPU 10. The sensors include a vehicle speed sensor and a remaining fuel level sensor. The in-vehicle sensor interface 13 transmits vehicle speed information acquired by the vehicle speed sensor and remaining fuel level information acquired by the remaining fuel level sensor to the CPU 10. Further, the in-vehicle sensor interface 13 connects the CPU 10 to various switches mounted on the vehicle and allows the switches to transmit switch manipulation information to the CPU 10. In this application, the word “information” is used not only as an uncountable noun but also as a countable noun. Thus, a plurality of informations are recognized, for instance, as a plurality of pieces of information or as a plurality of information items.

The vehicle LAN interface 14 connects the CPU 10 to various control units, such as the air-conditioner control unit (air-conditioner control panel), the body control unit, the engine control unit, and the meters, and allows the control units to exchange data with the CPU 10. When, for instance, the CPU 10 receives air-conditioner switch manipulation information from the in-vehicle sensor interface 13, the CPU 10 transmits a control command to the air-conditioner control unit through the vehicle LAN interface 14. When a control command is transmitted from the air-conditioner control unit to an air conditioner and executed by the air conditioner, the air-conditioner control unit transmits an execution completion notice to the CPU 10 through the vehicle LAN interface 14. Further, the air-conditioner control unit transmits temperature and air flow rate settings for the use of the air conditioner to the CPU 10 through the vehicle LAN interface 14.

The storage portion 15 may be referred to as an information storage portion 15. The storage portion 15 stores various programs to be executed by the CPU 10 and various data received by the CPU 10. More specifically, the storage portion 15 stores vehicle speed information and remaining fuel level information transmitted from the in-vehicle sensor interface 13 as well as a total traveled distance calculated from the vehicle speed information. The storage portion 15 also stores the settings for the use of the air conditioner, which are transmitted from the vehicle LAN interface 14. Besides, the storage portion 15 stores vehicle maintenance information such as oil change intervals, periodic inspection intervals, and filter change intervals. The power supply portion 16 supplies electrical power to the CPU 10.

The communication assistance apparatus 20 includes a proximity wireless interface 21, a wireless power feed interface 22 (wireless power feed portion), an in-vehicle adapter 23, and a recessed portion 24 (see FIG. 4). The recessed portion 24 is formed in a vehicle compartment to retain the in-vehicle adapter 23. A retaining portion for the communication assistance apparatus 20 includes the in-vehicle adapter 23 and the recessed portion 24.

The proximity wireless interface 21 may be referred to as a communication portion 21. The proximity wireless interface 21 provides proximity high-speed wireless transfer or communication based, for instance, on TransferJet (registered trademark, ISO/IEC 17568 and ISO/IEC 17569). This proximity high-speed wireless communication method, which establishes wireless communication between two specific communication units placed in proximity to each other, serves as a wireless communication method for establishing wireless communication only between two specific units. Here, Wi-Fi (registered trademark), Bluetooth (registered trademark), or other one-to-many wireless communication method (also referred to as an one-to-many wireless connection method), which simultaneously establishes one-to-many wireless connections, may be used to connect the mobile terminal 50 acting as one of many and unspecified communication units. In contrast to such one-to-many wireless connection methods, the proximity high-speed wireless communication method (also referred to as an one-to-one wireless connection method) is capable of establishing stable one-to-one wireless connections.

The proximity wireless interface 21 receives, by proximity high-speed wireless communication, data from the mobile terminal 50, and transmits, by proximity high-speed wireless communication, data received from the in-vehicle apparatus 30 to the mobile terminal 50. The wireless power feed interface 22, which may be referred to as a wireless power feed portion 22, is capable of wirelessly supplying electrical power to a wireless power receiving interface 53 of the mobile terminal 50 retained by the retaining portion.

The in-vehicle adapter 23 is shaped to match the shape of the mobile terminal 50 and disposed between the recessed portion 24 in the vehicle and the mobile terminal 50. The retaining portion, which includes the in-vehicle adapter 23 and the recessed portion 24, retains the mobile terminal 50 so as to establish proximity high-speed wireless communication between the proximity wireless interface 21 and the mobile terminal 50. A member that forms the in-vehicle adapter 23 and the recessed portion 24 is made of resin or other material that does not interfere with proximity wireless communication.

A communication system according to the present disclosure includes the communication assistance apparatus 20 and the CPU 10. The CPU 10 transmits at least either the total distance traveled by the vehicle, which is stored in the storage portion 15, or the vehicle maintenance information to the later-described mobile terminal 50 through the communication assistance apparatus 20 and causes a display 56 to display the transmitted information. This allows the CPU 10 to use the mobile terminal 50 as a meter of the vehicle.

Further, the CPU 10 causes the display 56 of the mobile terminal 50 to display the settings for the use of the vehicle's air conditioner, which are stored in the storage portion 15, through the communication assistance apparatus 20. This allows the CPU 10 to use the mobile terminal 50 as a control panel for the air conditioner.

The CPU 10 receives input information, which is input by manipulating a touch panel 57 and various switches 58 on the later-described mobile terminal 50, through the communication assistance apparatus 20 and controls the air conditioner on the basis of the received input information.

The CPU 10 transmits illumination information about headlights (lighting) of the vehicle to the mobile terminal 50 through the communication assistance apparatus 20, changing the brightness of the display 56 of the mobile terminal 50. The headlight of the vehicle illuminating signifies that the inside of the vehicle is dark. This provides adequate contrast even when the brightness of the display 56 is lowered. If the headlights are extinguished, the CPU 10 exercises reverse control.

Additionally, the CPU 10 notifies the mobile terminal 50 through the communication assistance apparatus 20 that the mobile terminal 50 is retained by the retaining portion, and inhibits an image displayed on the mobile terminal 50 from rotating.

Besides, the CPU 10 notifies the mobile terminal 50 through the communication assistance apparatus 20 of the shift position of the vehicle's transmission. If the vehicle's transmission is placed in reverse shift, the CPU 10 causes the mobile terminal 50 to display a rear view taken from the vehicle. More specifically, when the vehicle moves rearward, the CPU 10 allows the user to use the mobile terminal 50 as a rear-view monitor by causing the mobile terminal 50 to display an image captured by an in-vehicle camera mounted on the rear of the vehicle.

The mobile terminal 50, which may be referred to as a mobile information terminal 50, is a smartphone or tablet that includes a CPU 51, a proximity wireless interface 52, a wireless power receiving interface 53, a power supply control portion 54, a battery 55, a display 56 (screen), a touch panel 57, various switches 58, a storage portion 59, and a notification portion 60.

The proximity wireless interface 52, which may be referred to as a mobile terminal communication portion 52, is a TransferJet (registered trademark) or other wireless interface that provides proximity high-speed wireless communication. As described in conjunction with the proximity wireless interface 21, this proximity high-speed wireless communication method establishes wireless communication between two specific communication units placed in proximity to each other. This proximity high-speed wireless communication method establishes wireless communication only between two specific units, enabling stable one-to-one wireless connections.

The proximity wireless interface 52 receives data from the proximity wireless interface 21 by proximity high-speed wireless communication, and transmits, by proximity high-speed wireless communication, data received from the CPU 51 to the proximity wireless interface 21. The proximity wireless interface 52 and the proximity wireless interface 21 exchange data without making a physical contact. Although not shown, the mobile terminal 50 includes a wireless interface that provides Wi-Fi (registered trademark), Bluetooth (registered trademark), or other wireless communication.

The wireless power receiving interface 53, which may be referred to as a wireless power receiving portion 53, receives electrical power from the wireless power feed interface 22 without making a physical contact with the wireless power feed interface 22. The power supply control portion 54 stores the electrical power received by the wireless power receiving interface 53 in the battery 55.

The display 56 is formed of a liquid-crystal display or an organic electroluminescence (EL) display. The touch panel 57 forms touch switches integrally with the display 56. The switches 58 are mechanical switches including a power switch.

The storage portion 59 stores (i) vehicle applications to be executed by the CPU 51 and (ii) data of the various in-vehicle units, which is transmitted from the in-vehicle apparatus 30. The user can download vehicle applications that suit user preferences. The vehicle applications include an application authorized by a vehicle manufacturer.

When the connection between the communication assistance apparatus 20 and the in-vehicle apparatus 30 is established by proximity high-speed wireless communication in compliance with a command from the CPU 10, the communication assistance apparatus 20 causes the notification portion 60 to notify the user of the established connection. More specifically, the notification portion 60, which is formed integrally with the display 56, causes the display 56 to display information indicative of the established connection. Alternatively, the notification portion 60, which is a loudspeaker, outputs an audible message to notify the user of the established connection.

The CPU 51 executes a vehicle application to enable the mobile terminal 50 to implement the functions of an in-vehicle information terminal. More specifically, when the CPU 51 executes the vehicle application, the mobile terminal 50 receives various data acquired by various in-vehicle units from the in-vehicle apparatus 30 and displays the received data on the display 56 or stores the received data in the storage portion 59.

Further, in compliance with a command from the CPU 10, the communication assistance apparatus 20 receives illumination information about the vehicle's headlights (lighting) and coordinates the brightness of the display 56 of the mobile terminal 50 with an on/off operation of the headlights. More specifically, the communication assistance apparatus 20 transmits a command from the CPU 10 to the mobile terminal 50 so that when the vehicle's headlights are illuminated, the brightness of the display 56 of the mobile terminal 50 is lower than when the vehicle's headlights are extinguished.

In compliance with a command from the CPU 10, the communication assistance apparatus 20 receives a notice indicative of the mobile terminal 50 retained by the retaining portion and inhibits an image displayed on the mobile terminal 50 from rotating. More specifically, the communication assistance apparatus 20 transmits the command from the CPU 10 to the mobile terminal 50 in order to inhibit the image displayed on the mobile terminal 50 from rotating.

In compliance with a command from the CPU 10, the communication assistance apparatus 20 receives the position of the vehicle's transmission from a mobile information control apparatus 30. If the vehicle's transmission is placed in reverse, the communication assistance apparatus 20 causes the mobile terminal 50 to display a rear view taken from the vehicle. More specifically, the communication assistance apparatus 20 transmits the command from the CPU 10 to the mobile terminal 50 so that, if the vehicle's transmission is placed in reverse, the display 56 of the mobile terminal 50 displays a rear view taken from the vehicle.

Besides, when the CPU 51 executes an application authorized by a vehicle manufacturer, the display 56 of the mobile terminal 50 displays a menu for manipulating the various in-vehicle units. In response to an option selected by the user from a manipulating menu, the mobile terminal 50 transmits a control command to the in-vehicle apparatus 30 in order to manipulate a target in-vehicle unit. Consequently, when the CPU 51 executes a vehicle application while the mobile terminal 50 is connected to the in-vehicle apparatus 30 by continuous proximity high-speed wireless communication, the user can use the mobile terminal 50 as an in-vehicle information terminal.

When, in particular, a vehicle application for implementing user-desired in-vehicle information terminal functions is installed on the mobile terminal 50, the user can customize the mobile terminal 50 to suit user preferences and use the mobile terminal 50 as a desired in-vehicle information terminal. This eliminates the necessity of investing in functions unnecessary for the user. The user merely has to invest in necessary functions.

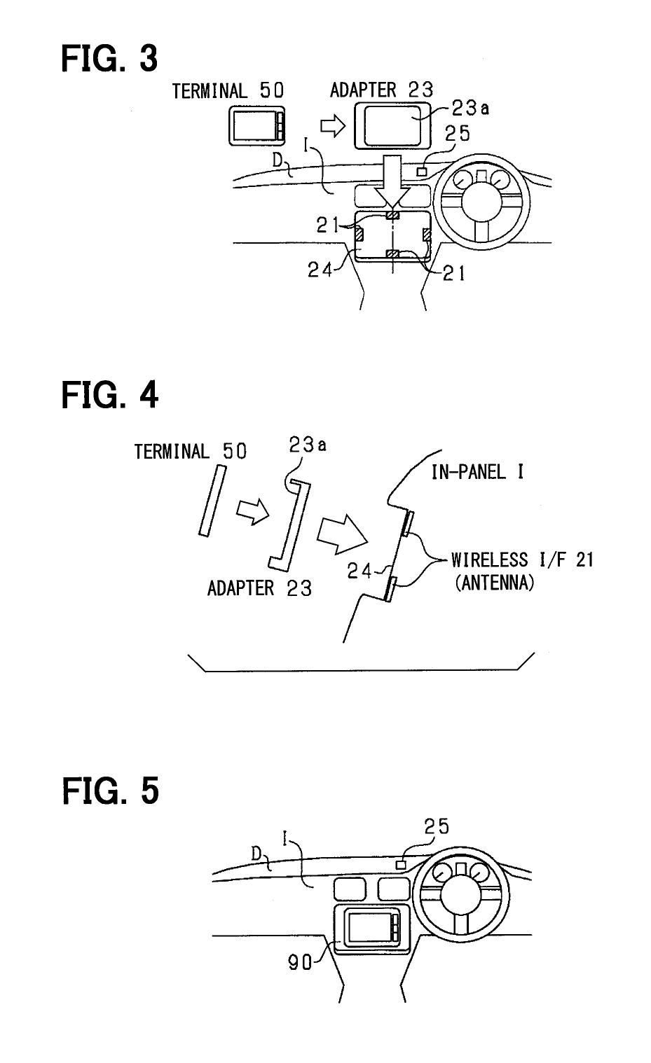

If the connection between the mobile terminal 50 and the in-vehicle apparatus 30 is not established by proximity high-speed wireless communication when the mobile terminal 50 is retained by the retaining portion, the communication assistance apparatus 20 illuminates an indicator 25 (notification apparatus) in compliance with a command from the CPU 10 to notify the user that the connection is not established (see FIG. 3).

In order to use the mobile terminal 50 as an in-vehicle information terminal, proximity high-speed wireless communication needs to be continuously establishable. Therefore, it is necessary to mount the communication assistance apparatus 20 at an appropriate place in a vehicle compartment and retain the mobile terminal 50 within the vehicle compartment. The following describes the place within a vehicle compartment at which the communication assistance apparatus 20 is to be mounted and the method of mounting the communication assistance apparatus 20. Using the mobile terminal 50 by a driver of the vehicle as an in-vehicle information terminal will be now described with reference to FIGS. 3 and 4.

In order to enable the driver to use the mobile terminal 50 as an in-vehicle information terminal, the mobile terminal 50 needs to be secured to a place within a vehicle compartment that is easily viewable by the driver. That is why the mobile terminal 50 is secured to an instrument panel I of the vehicle.

Hence, the recessed portion 24 having a rectangular cross section is formed on the instrument panel I to retain the in-vehicle adapter 23. The proximity wireless interface 21 is disposed adjacent to the recessed portion 24. More specifically, the proximity wireless interface 21 is disposed at the center of at least one side of the bottom surface of the recessed portion 24 having a rectangular cross section. The user disposes the in-vehicle adapter 23, which is shaped like a rectangular plate, in the recessed portion 24. The recessed portion 24 and the in-vehicle adapter 23 are shaped and dimensioned to engage each other. Further, the user allows the mobile terminal 50 to be retained by a mounting surface 23a of the in-vehicle adapter 23 such that the position of the proximity wireless interface 21 disposed at the center of at least one side of the recessed portion 24 agrees with the position of the proximity wireless interface 52 built in the mobile terminal 50. This establishes continuous proximity wireless communication between the mobile terminal 50 and the in-vehicle apparatus 30 in a moving vehicle.

Under normal conditions, the in-vehicle adapter 23 is left disposed on the recessed portion 24. The user detaches the mobile terminal 50 from the in-vehicle adapter 23 or attaches the mobile terminal 50 to the in-vehicle adapter 23 as needed to use the mobile terminal as a part of an in-vehicle information terminal.

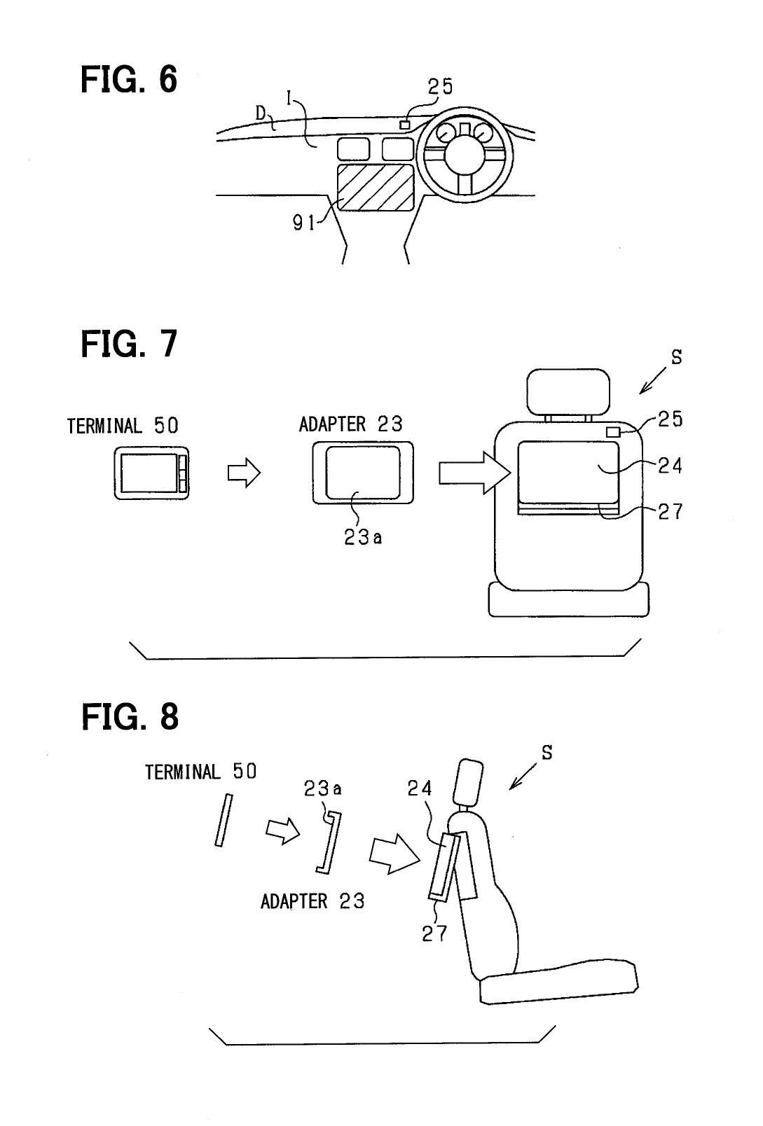

When the in-vehicle adapter 23 is removed from the recessed portion 24, a dedicated in-vehicle display 90 or a decorative panel 91 can be disposed on the recessed portion 24. If the user does not possess a mobile terminal 50 or intends to use a dedicated in-vehicle information terminal, the user can dispose the dedicated in-vehicle display 90 in the recessed portion 24 and use the functions of an in-vehicle information terminal, as in FIG. 5. If, by contrast, the user does not intend to use an in-vehicle information terminal, the user can dispose the decorative panel 91 in the recessed portion 24 to cover it, as in FIG. 6.

The recessed portion 24 may be formed on a dashboard D that is easily viewable by the driver. The recessed portion 24 may be formed on at least either the instrument panel I or the dashboard D. The indicator 25 may be disposed on an easily viewable portion of the instrument panel I or dashboard D.

The following describes using the mobile terminal 50 by a passenger in a rear seat as an in-vehicle information terminal, with reference to FIGS. 7 to 10. In order to let a passenger in a rear seat use the mobile terminal 50 as an in-vehicle information terminal, the mobile terminal 50 needs to be secured to a portion of a vehicle compartment that is easily viewable by the passenger in the rear seat. Hence, the mobile terminal 50 is secured to the rear surface of a seat S that is either a driver seat or a front passenger seat, in the same manner regardless whether to be secured to the driver seat or to the front passenger seat.

As in FIGS. 7 and 8, a board 27 shaped like a rectangular plate is mounted on the rear surface of a seat S. The height of the board 27 is adjusted so that the board 27 is easily viewable by a rear seat passenger. The recessed portion 24 having a rectangular cross section is formed on the board in order to retain the in-vehicle adapter 23. The proximity wireless interface 21 is disposed at the center of at least one side of the bottom surface of the recessed portion 24 having a rectangular cross section. The user disposes the in-vehicle adapter 23, which is shaped like a rectangular plate, in the recessed portion 24. Further, the user allows the mobile terminal 50 to be retained by the mounting surface 23a of the in-vehicle adapter 23 such that the position of the proximity wireless interface 21 disposed at the center of at least one side of the recessed portion 24 agrees with the position of the proximity wireless interface 52 built in the mobile terminal 50. The indicator 25 may be disposed on an easily viewable portion of the seat S.

The board 27 is mounted on the rear surface of the seat S. The upper end of the board 27 is rotatably supported on the rear surface of the seat S, allowing the lower end of the board 27 to be pulled out from the seat S toward the passenger in the rear seat. Hence, when the board 27 is pulled out from the rear of the seat S toward the passenger in the rear seat, the mobile terminal 50 secured to the board 27 remains tilted and easily viewable by the passenger in the rear seat. When the mobile terminal 50 is not mounted on the in-vehicle adapter 23, the board 27 can be returned to the rear surface of the seat S while the in-vehicle adapter 23 is disposed on the recessed portion 24. This ensures that the passenger can enter and exit the vehicle without being obstructed.

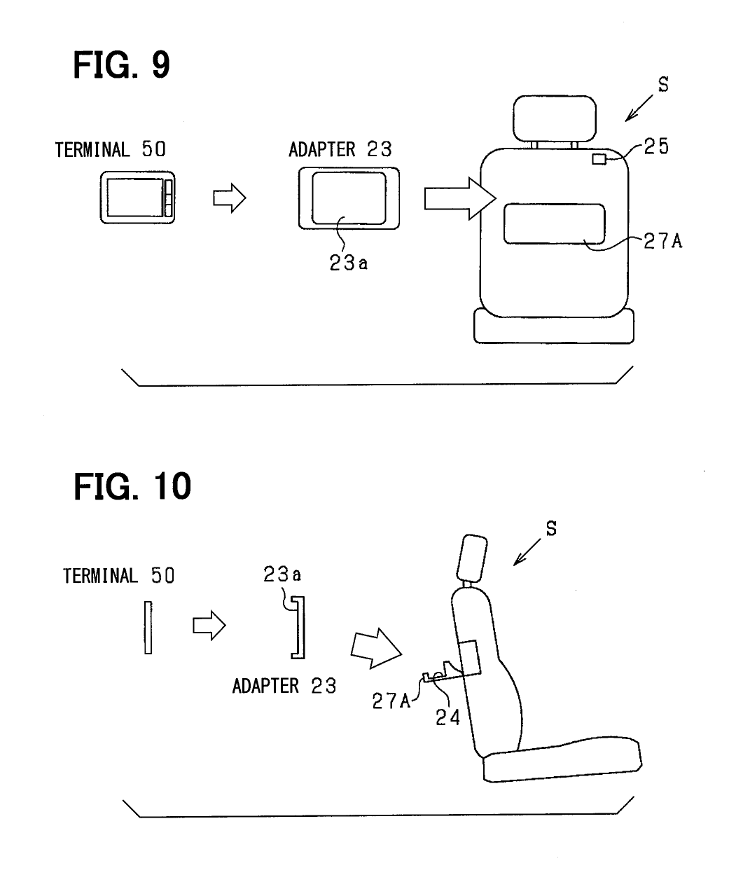

Alternatively, the mobile terminal 50 may be secured to the rear surface of the seat S as described below. As in FIGS. 9 and 10, a board 27A shaped like a rectangular plate is mounted on the rear surface of the seat S. The height of the board 27A is adjusted so that the board 27A is easily viewable by a rear seat passenger. The lower end of the board 27A is rotatably supported on the rear surface of the seat S. Therefore, the upper end of the board 27A can be pulled out from the rear surface of the seat S toward the passenger in the rear seat. The recessed portion 24 having a rectangular cross section is formed on a surface of the board 27A that is contact with the rear surface of the seat. The recessed portion 24 is formed so as to retain the lower end of the in-vehicle adapter 23.

The proximity wireless interface 21 is disposed adjacent to the recessed portion 24. The user disposes the lower end of the in-vehicle adapter 23, which is shaped like a rectangular plate, in the recessed portion 24. Further, the user allows the mobile terminal 50 to be retained by the mounting surface 23a of the in-vehicle adapter 23 such that the proximity wireless interface 52 built in the mobile terminal 50 is positioned at the lower end. When the mobile terminal 50 is not mounted on the in-vehicle adapter 23, the in-vehicle adapter 23 can be removed from the recessed portion 24 to return the board 27A to the rear surface of the seat S. This ensures that the passenger can enter and exit the vehicle without being obstructed.

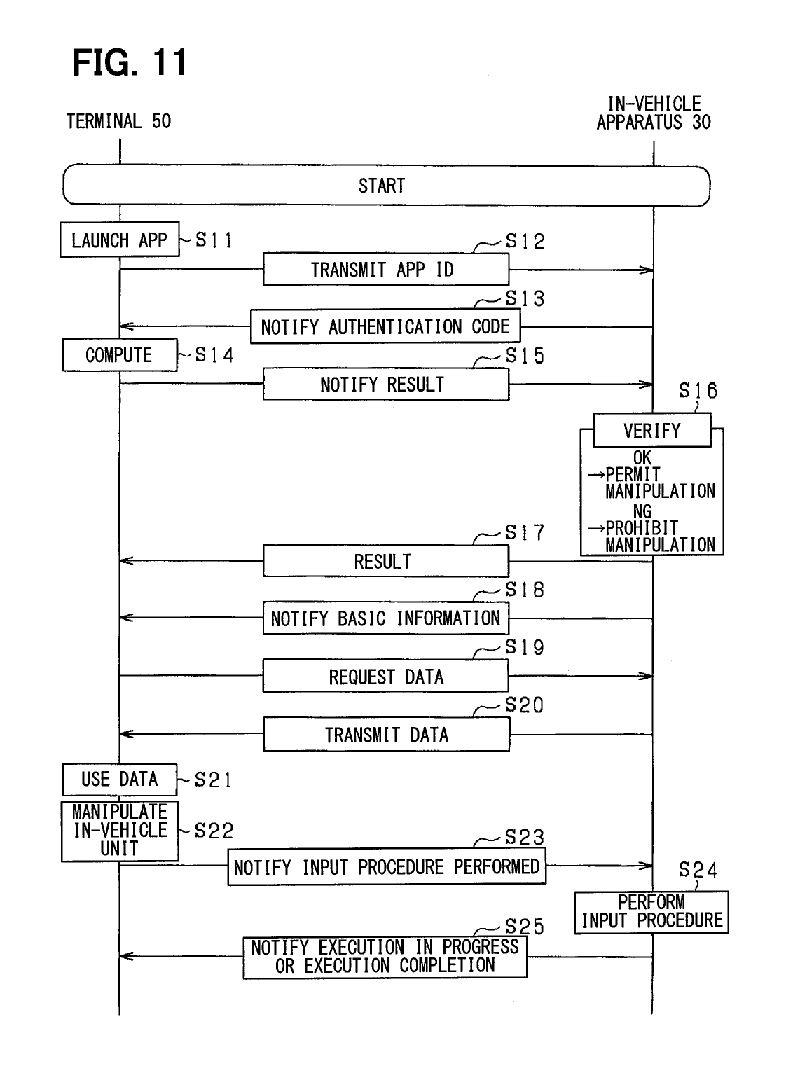

The following describes a process performed when the mobile terminal 50 retained by the in-vehicle adapter 23 is used as an in-vehicle information terminal, with reference to a sequence diagram of FIG. 11. A series of processing is executed after proximity wireless communication is established between the mobile terminal 50 and the in-vehicle information terminal.

Here, safe driving essentially requires the manipulation of in-vehicle units to be restricted during driving. Hence, vehicle manufacturers, for example, authorize vehicle applications that restrict the manipulation of in-vehicle units during driving. When a vehicle application authorized in a predefined manner by a vehicle manufacturer or other similar institution is launched by the mobile terminal 50, the in-vehicle apparatus 30 permits the mobile terminal 50 to manipulate various in-vehicle units. When, in contrast, a vehicle application not authorized by a vehicle manufacturer or other similar institution is launched by the mobile terminal 50, the in-vehicle apparatus 30 prohibits the mobile terminal 50 from manipulating various in-vehicle units and simply transmits various data to the mobile terminal 50. More specifically, following S11 to S17 are performed.

First, in S11, the mobile terminal 50 launches a vehicle application. Next, in S12, the mobile terminal 50 transmits a vehicle application launch notification and the ID of the vehicle application to the in-vehicle apparatus 30. The ID of the vehicle application is identification information attached to identify the vehicle application.

Next, in S13, upon receipt of the vehicle application launch notification and the ID of the vehicle application from the mobile terminal 50, the in-vehicle apparatus 30 transmits an authentication code to the mobile terminal 50. The authentication code authenticates the vehicle application launched by the mobile terminal 50 as an application authorized by a vehicle manufacturer or other similar institution.

In S14, upon receipt of the authentication code from the in-vehicle apparatus 30, the mobile terminal 50 performs a computation on the authentication code and information attached to the launched vehicle application. In S15, the mobile terminal 50 transmits the result of the computation to the in-vehicle apparatus 30.

In S16, the in-vehicle apparatus 30 verifies the computation result received from the mobile terminal 50. If the vehicle application launched by the mobile terminal 50 is authorized, setup is performed to permit the mobile terminal 50 to manipulate various in-vehicle units. If the vehicle application launched by the mobile terminal 50 is not authorized, setup is performed to prohibit the mobile terminal 50 from manipulating the various in-vehicle units. In S17, the in-vehicle apparatus 30 transmits the result of the verification to the mobile terminal 50.

In S18, the in-vehicle apparatus 30 transmits basic information to the mobile terminal 50. The basic information includes the name of a vehicle manufacturer, the model name of the vehicle, and the types of data transmittable to the mobile terminal 50.

In S19, upon receipt of the basic information from the in-vehicle apparatus 30, the mobile terminal 50 transmits a transmission start request for desired transmittable data to the in-vehicle apparatus 30. When the verification result is received from the in-vehicle apparatus 30, the mobile terminal 50 may use the notification portion 60 to notify the user of the verification result. More specifically, the mobile terminal 50 may use the display 56 or the loudspeaker to display information or output an audible message for the purpose of indicating whether the manipulation of the various in-vehicle units is permitted or prohibited.

In S20, the in-vehicle apparatus 30 start transmitting requested data to the mobile terminal 50 in response to the transmission start request from the mobile terminal 50. The requested data includes a vehicle speed, a traveled distance, headlight on/off data, an engine revolving speed, and images captured by the in-vehicle cameras. The data are electronically authenticated to prevent them from being tampered with.

In S21, the mobile terminal 50 uses vehicle data received from the in-vehicle apparatus 30. The user may display the vehicle speed to use the mobile terminal 50 as a speedometer, change the brightness of the display 56 in coordination with headlight on/off, or display an image captured by an in-vehicle camera to use the mobile terminal 50 as a vehicle periphery monitor. Further, the user may display the traveled distance and maintenance information to use the mobile terminal 50 as a meter or display air-conditioner settings to use the mobile terminal 50 as an air-conditioner control panel.

If the verification result received in S17 indicates that the manipulation is permitted, the user, in S22, manipulates in-vehicle units from the mobile terminal 50. If the user intends to manipulate the air conditioner, the user uses the display 56 of the mobile terminal 50 to display an air-conditioner manipulation menu and manipulates the manipulation menu to input a command. Then, in S23, the mobile terminal 50 transmits a control command based on an input procedure performed by the user to the in-vehicle apparatus 30 through the communication assistance apparatus 20.

In S24, the in-vehicle apparatus 30 processes the input procedure performed by the user. More specifically, the in-vehicle apparatus 30 transmits the control command received from the mobile terminal 50 to the air conditioner, which is a target unit. Next, in S25, the in-vehicle apparatus 30 receives a control command processing completion signal from the air conditioner, which is the target unit, and then notifies the mobile terminal 50 that the control command is being executed or completely executed. If, in S22, the user performs an input procedure with respect to an in-vehicle unit from the mobile terminal 50 in a situation where the verification result received in S17 indicates that the manipulation is prohibited, the in-vehicle apparatus 30 does not process the input procedure, but notifies the mobile terminal 50 in S25 that the control command cannot be executed.

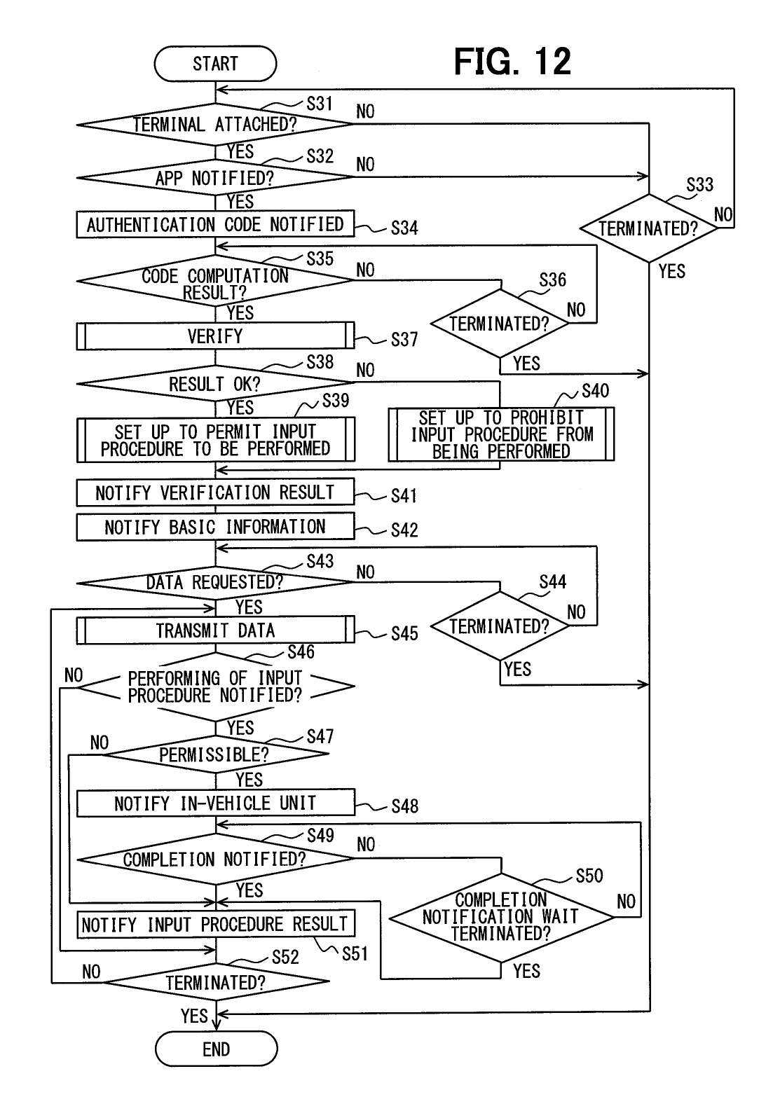

The following describes a process performed when the in-vehicle apparatus 30 communicates with the mobile terminal 50, with reference to a flowchart of FIG. 12. The process is performed at predetermined intervals when the in-vehicle system is started up.

First, it is determined in S31 whether the mobile terminal 50 is placed in the recessed portion 24. A sensor or other similar apparatus that detects the mobile terminal 50 is disposed on the recessed portion 24 or on the in-vehicle adapter 23. Whether the mobile terminal 50 is placed in the recessed portion 24 is determined based on a value detected by the sensor or other similar apparatus. If it is determined that the mobile terminal 50 is not placed in the recessed portion 24 (NO), processing proceeds to S33 and determines whether or not to terminate the process. If the in-vehicle system is stopped, the process is determined to be terminated (YES) and then terminated. If, by contrast, the in-vehicle system is running, the process is determined to be continued (NO), and then processing returns to S31.

If the result of determining in S31 indicates that the mobile terminal 50 is placed in the recessed portion 24 (YES), processing proceeds to S32 and determines whether a vehicle application launch notification is received from the mobile terminal 50. If the vehicle application launch notification is not received (NO), processing proceeds to S33 and determines whether or not to terminate the process.

If the vehicle application launch notification is received from the mobile terminal 50 in S32 (YES), processing proceeds to S34 and notifies the mobile terminal 50 of an authentication code. Then, in S35, it is determined whether the result of authentication code computation is received from the mobile terminal 50. If the result of authentication code computation is not received (NO), processing proceeds to S36 and determines whether or not to terminate the process. If the process is determined in S36 to be terminated (YES), the process terminates. If, by contrast, the process is determined to be continued (NO), processing returns to S35.

If the result of authentication code computation is received (YES), processing proceeds to S37 and verifies the result received from the mobile terminal 50. Then, in S38, it is determined whether or not to permit the mobile terminal 50 to manipulate in-vehicle units. If the manipulation is permitted in S38 (YES), processing proceeds to S39 and performs setup to permit an input procedure performed from the mobile terminal 50. If, by contrast, the manipulation is prohibited in S38 (NO), processing proceeds to S40 and performs setup to prohibit an input procedure from being performed from the mobile terminal 50. In this instance, the indicator 25 may be illuminated in a color different from a case where proximity high-speed wireless communication cannot be established, thereby notifying the user that setup is performed to prohibit an input procedure from being performed. Next, in S41, the verification result indicative of the permission or prohibition of the input procedure is transmitted to the mobile terminal 50.

In S42, the basic information including the name of a vehicle manufacturer is transmitted to the mobile terminal 50. Then, in S43, it is determined whether a data transmission start request is received from the mobile terminal 50. If the data transmission start request is not received (NO), processing proceeds to S44 and determines whether or not to terminate the process. If the process is determined to be terminated (YES), the process terminates. If the process is determined to be continued (NO), processing returns to S43.

If the data transmission start request is received in S43 (YES), processing proceeds to S45 and transmits requested data and images captured by the cameras to the mobile terminal 50.

In S46, it is determined whether a notification of an input procedure is received from the mobile terminal 50. If the notification of an input procedure is not received (NO), processing proceeds to S52 and determines whether or not to terminate the process. If the process is determined to be terminated (YES), the process terminates. If, by contrast, the process is determined to be continued (NO), processing returns to S45.

If the notification of an input procedure is received in S46 (YES), processing proceeds to S47 and determines whether setup is performed to permit an input procedure performed from the mobile terminal 50. Thus, whether S39 is completed is determined.

If setup is performed in S47 to permit the input procedure to be performed (YES), processing proceeds to S48. In S48, a control command transmitted from the mobile terminal 50 is transmitted to a target in-vehicle unit. Next, in S49, it is determined whether a control command processing completion notification is received from the in-vehicle unit to which the control command was transmitted in S48. If the control command processing completion notification is not received in S49 (NO), processing proceeds to S50 and determines whether or not to terminate a completion notification wait. If the completion notification wait is determined to be terminated (YES), processing proceeds to S51. If, by contrast, the completion notification wait is determined to be continued (NO), processing returns to S49.

In S51, the result of the input procedure is transmitted to the mobile terminal 50. If setup is performed in S47 to prohibit an input procedure from being performed, the mobile terminal 50 is notified of the prohibition of an in-vehicle unit manipulation. If setup is performed in S47 to permit an input procedure to be performed and the control command processing completion notification is received from the in-vehicle unit in S49, or if setup is performed in S47 to permit the input procedure to be performed and the completion notification wait is determined in S50 to be terminated, the mobile terminal 50 is notified of an ongoing execution of the control command or the execution completion of the control command.

In S52, it is determined whether or not to terminate the process. If the process is determined to be terminated (YES), the process terminates. If, by contrast, the process is determined to be continued (NO), processing returns to S45.

The first embodiment, which has been described above, provides the following advantages.
The proximity high-speed wireless communication method used in the present embodiment of the present disclosure establishes wireless communication between two specific communication units placed in proximity to each other, i.e., only between two specific units. Here, Wi-Fi (registered trademark), Bluetooth (registered trademark), or other one-to-many wireless communication method (also referred to as an one-to-many wireless connection method) simultaneously establishes one-to-many wireless connections. In contrast to such one-to-many wireless connection method, the proximity high-speed wireless communication method (also referred to as an one-to-one wireless connection method) is capable of establishing stable one-to-one wireless connections. The use of this proximity high-speed wireless communication method can establish stable one-to-one high-speed wireless communication between the mobile terminal 50 and the in-vehicle apparatus 30. Therefore, installing a vehicle application on the mobile terminal 50 enables the in-vehicle apparatus 30 to transmit data acquired by various units to the mobile terminal 50 and enables the mobile terminal 50 to transmit control commands for manipulating the various units to the in-vehicle apparatus 30. The functions of an in-vehicle information terminal can thus be incorporated into the mobile terminal 50. Besides, as the in-vehicle apparatus 30 is wirelessly connected to the mobile terminal 50, no trouble is caused by a connection based on a physical contact.
When a vehicle application for implementing the functions of a user-desired in-vehicle information terminal is installed on the mobile terminal 50, the user can customize the mobile terminal 50 to suit user preferences and use the mobile terminal 50 as a desired in-vehicle information terminal. This eliminates the necessity of investing in functions unnecessary for the user. The user merely has to invest in necessary functions. Besides, a manufacturer that develops the in-vehicle system can reduce the man-hours required for the development of a vehicle application.
For proximity high-speed wireless communication, the mobile terminal 50 is retained adjacent to the proximity wireless interface 21. Therefore, when the wireless power feed interface 22 is disposed adjacent to the proximity wireless interface 21, power can be wirelessly supplied to the mobile terminal 50 retained by the retaining portion. Hence, the mobile terminal 50 can be steadily used as an in-vehicle information terminal.
The in-vehicle adapter 23 shaped to match the shape of the mobile terminal 50 is retained by the recessed portion 24 that is formed on at least either the instrument panel I or the dashboard D. Therefore, the mobile terminal 50 in any shape can be secured to at least either the instrument panel I or the dashboard D. Further, as the proximity wireless interface 21 is disposed adjacent to the recessed portion 24, proximity high-speed wireless communication can be properly established between the proximity wireless interface 21 and the proximity wireless interface 52 of the mobile terminal 50 that is secured to the recessed portion 24 through the in-vehicle adapter 23. Consequently, the driver can use the mobile terminal 50, which is secured to at least either the instrument panel I or the dashboard D, as an in-vehicle information terminal.
The in-vehicle adapter 23 shaped to match the shape of the mobile terminal 50 is retained by the recessed portion 24 that is formed on the rear surface of a seat S that is at least either the driver seat or the front passenger seat. Therefore, the mobile terminal 50 in any shape can be secured to the rear surface of the seat S that is at least either the driver seat or the front passenger seat. Further, as the proximity wireless interface 21 is disposed adjacent to the recessed portion 24, proximity high-speed wireless communication can be properly established between the proximity wireless interface 21 and the proximity wireless interface 52 of the mobile terminal 50 that is secured to the recessed portion 24 through the in-vehicle adapter 23. Consequently, a passenger in the rear seat can use the mobile terminal 50, which is secured to the rear surface of the seat S that is at least either the driver seat or the front passenger seat, as an in-vehicle information terminal.

When the dedicated in-vehicle display 90 is installed in place of the in-vehicle adapter 23, an in-vehicle information terminal is configured on the recessed portion 24. Therefore, when the user does not possess a mobile terminal 50 or intends to use a dedicated in-vehicle information terminal, the user can use the functions of the dedicated in-vehicle information terminal.
When the decorative panel 91 is installed in place of the in-vehicle adapter 23, the recessed portion 24 in the vehicle is covered. Therefore, when the user does not need to use an information terminal in the vehicle, the user can make a vehicle compartment aesthetically comfortable.
If the connection between the mobile terminal 50 and the in-vehicle apparatus 30 is not established by proximity high-speed wireless communication, the indicator 25 notifies the user that the connection is not established. Therefore, the user can try again to establish the connection.
The mobile terminal 50 announces that the connection between the mobile terminal 50 and the in-vehicle apparatus 30 is established by proximity high-speed wireless communication. Therefore, the user can become aware of the establishment of the connection. Further, if the establishment of the connection is not announced although the mobile terminal 50 is secured to the retaining portion, the user can become aware that the connection between the mobile terminal 50 and the in-vehicle apparatus 30 is not successfully established by proximity high-speed wireless communication.
The total distance traveled by the vehicle is typically recorded by a meter of the vehicle. Therefore, if the meter of the vehicle becomes defective or needs replacement, the recorded total traveled distance cannot typically be restored. In the present embodiment, however, the storage portion 15 records the total traveled distance. Therefore, even if the meter of the vehicle becomes defective or needs replacement, the present embodiment can restore the recorded total traveled distance.
The total distance traveled by the vehicle and maintenance information are recorded by the storage portion 15, transmitted to the mobile terminal 50, and displayed on the display 56 of the mobile terminal 50. Therefore, the mobile terminal 50, which is connected to the in-vehicle apparatus 30 through the communication assistance apparatus 20, can be used as a meter of the vehicle.
Temperature, air flow rate, and other settings for the use of the vehicle's air conditioner are recorded by the storage portion 15, transmitted to the mobile terminal 50, and displayed on the display 56 of the mobile terminal 50. Therefore, the mobile terminal 50 can be used as an air-conditioner control panel.
The CPU 10 controls the air conditioner on the basis of information input to the mobile terminal 50. Therefore, the mobile terminal 50 can be used as an air-conditioner control panel.
When the headlights of the vehicle illuminate, the inside of the vehicle is darker than when the headlights of the vehicle are extinguished. When the brightness of the display 56 of the mobile terminal 50 is lowered in coordination with an on/off operation of the headlights of the vehicle, the mobile terminal 50 can be used as an in-vehicle information terminal.

The image displayed on the mobile terminal 50 is fixed so that it does not rotate while the mobile terminal 50 is retained by the retaining portion. Therefore, even if the vehicle pitches or otherwise oscillates during its travel, the user can view a fixed image that does not rotate with respect to the display 56.

When the vehicle's transmission is placed in reverse, the display 56 of the mobile terminal 50 displays a rear view taken from the vehicle. Therefore, when the vehicle's transmission is placed in reverse, the user can automatically use the mobile terminal 50 as a rear-view monitor.
If a vehicle application authorized, for instance, by a vehicle manufacturer is not launched by the mobile terminal 50, the mobile terminal 50 is prohibited from manipulating various in-vehicle units. This will save the risk of impairing driving safety.

### Second Embodiment

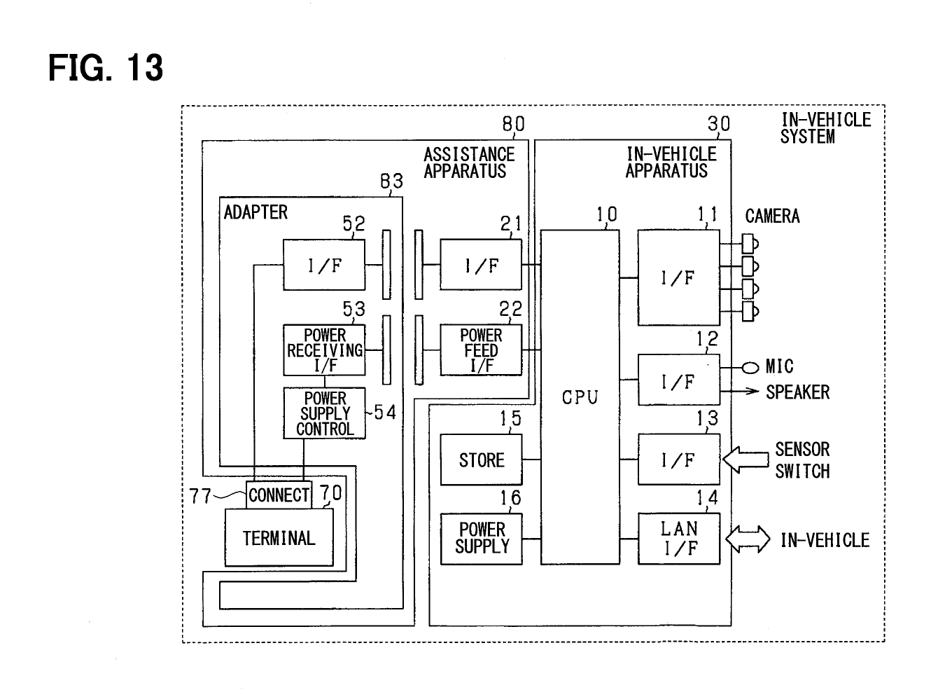

A second embodiment will now be described by explaining its difference from the first embodiment. The in-vehicle system according to the second embodiment includes a communication assistance apparatus 80, an in-vehicle apparatus 30, and a mobile terminal 70. Configurations of the communication assistance apparatus 80 and the mobile terminal 70 will be described below with reference to FIG. 13.

The communication assistance apparatus 80, which is connected to a CPU 10 of the in-vehicle apparatus 30, includes a proximity wireless interface 21 (communication portion), a wireless power feed interface 22 (wireless power feed portion), an in-vehicle adapter 83, and a recessed portion 24 that is formed in a vehicle compartment to retain the in-vehicle adapter 83. The in-vehicle adapter 83 includes a proximity wireless interface 52 (mobile terminal communication portion), a wireless power receiving interface 53 (wireless power receiving portion), and a power supply control portion 54. The proximity wireless interface 52, the wireless power receiving interface 53, and the power supply control portion 54, which are built in the in-vehicle adapter 83, are connected to a terminal connection portion 77 of the mobile terminal 70 that is retained by the in-vehicle adapter 83.

The proximity wireless interface 52 receives data transmitted from the proximity wireless interface 21 by proximity high-speed wireless communication, and transmits data received from the mobile terminal 70 to the proximity wireless interface 21 by proximity high-speed wireless communication. The wireless power receiving interface 53 receives electrical power that is wirelessly supplied from the wireless power feed interface 22. The power supply control portion 54 stores the electrical power received by the wireless power receiving interface 53 in a battery of the mobile terminal 70. Therefore, although the mobile terminal 70 does not include the proximity wireless interface 52, the wireless power receiving interface 53, and the power supply control portion 54, the mobile terminal 70 and the in-vehicle apparatus 30 can establish proximity high-speed wireless communication. In addition, the vehicle can wirelessly supply electrical power to the mobile terminal 70.

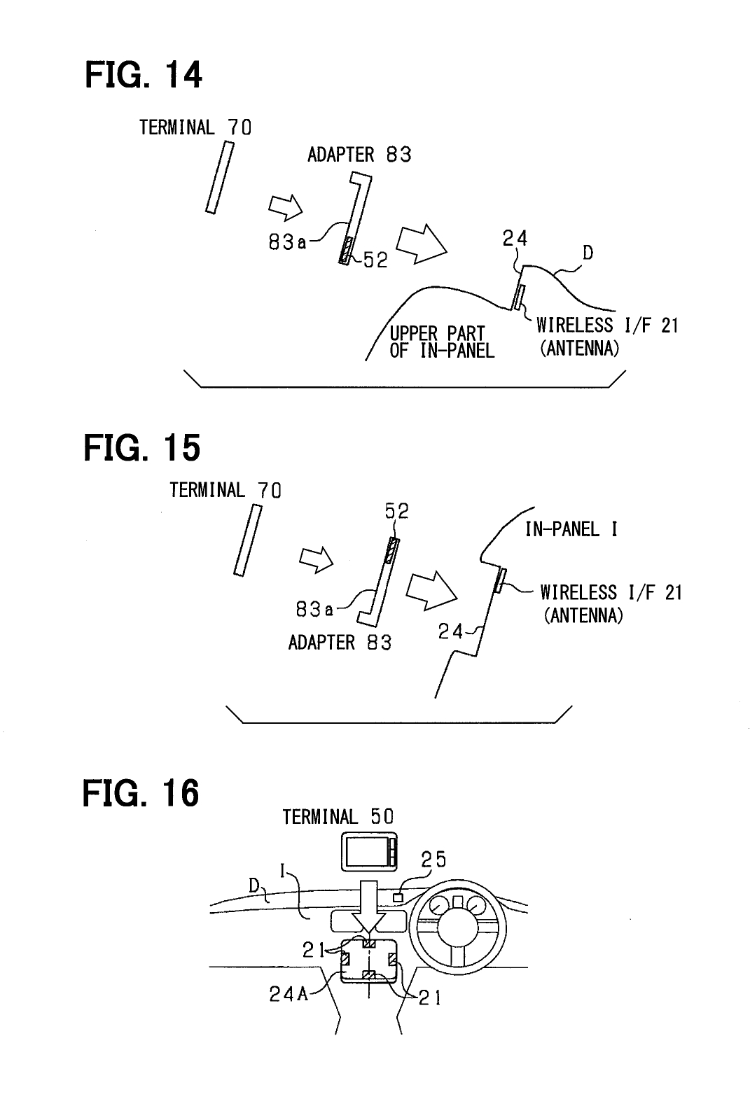

How the communication assistance apparatus 80 is installed when the driver uses the mobile terminal 70 as an in-vehicle information terminal will now be described with reference to FIGS. 14 and 15. As in FIG. 14, when the mobile terminal 70 is to be secured to the dashboard D for use, the recessed portion 24 is formed on the dashboard D. The proximity wireless interface 21 is disposed adjacent to the recessed portion 24. Further, the proximity wireless interface 52 is disposed at the center of at least one side of the in-vehicle adapter 83 shaped like a rectangular plate. The user disposes the in-vehicle adapter 83 on the recessed portion 24 such that the position of the proximity wireless interface 21 disposed adjacent to the recessed portion 24 agrees with the position of the proximity wireless interface 52 built in the in-vehicle adapter 83, and then connects the mobile terminal 70 to a mounting surface 83a of the disposed in-vehicle adapter 83. Even if the depth of the recessed portion 24 of the dashboard D is less than the length of a short side of the in-vehicle adapter 83 (the height of the disposed in-vehicle adapter 83), continuous proximity high-speed wireless communication can be established between the mobile terminal 70 and the in-vehicle apparatus 30 by securing the in-vehicle adapter 83 to the recessed portion 24 such that the proximity wireless interface 52 built in the in-vehicle adapter 83 is disposed at the lower end of the in-vehicle adapter 83.

Further, as in FIG. 15, when the mobile terminal 70 is to be secured to the instrument panel I for use, the recessed portion 24 having a rectangular cross section is formed on the instrument panel I. The proximity wireless interface 21 is disposed at the center of at least one side of the recessed portion 24 having a rectangular cross section. The user disposes the in-vehicle adapter 83 on the recessed portion 24 such that the position of the proximity wireless interface 21 disposed on the recessed portion agrees with the position of the proximity wireless interface 52 built in the in-vehicle adapter 83, and then connect the mobile terminal 70 to the mounting surface 83a of the disposed in-vehicle adapter 83.

When, for instance, the proximity wireless interface 21 is disposed at the upper end of the recessed portion 24 having a rectangular cross section and the proximity wireless interface 52 is disposed on one side of the in-vehicle adapter 83, the user secures the in-vehicle adapter 83 to the recessed portion 24 such that the proximity wireless interface 52 built in the in-vehicle adapter 83 is positioned at the upper end. Therefore, the recessed portion 24 can be designed so as to use the same in-vehicle adapter 83 by rotating the in-vehicle adapter 83 with respect to the recessed portion 24 no matter what location in the vehicle the in-vehicle adapter 83 is disposed at.

When a passenger in the rear seat uses the mobile terminal 70 as an in-vehicle information terminal, the communication assistance apparatus 80 can be mounted on the rear surface of the seat that is at least either the driver seat or the front passenger seat by combining the mounting method with the method of mounting to the rear surface of the seat S as described in conjunction with the first embodiment.

The second embodiment, which has been described above, provides the following advantages.
As the in-vehicle adapter 83 includes the proximity wireless interface 52, the proximity wireless interface 52 connected to the mobile terminal 70 receives data transmitted from the proximity wireless interface 21 by proximity high-speed wireless communication. Further, the data received from the mobile terminal 70 by the proximity wireless interface 52 is transmitted to the proximity wireless interface 21 by proximity high-speed wireless communication. Therefore, even if the mobile terminal 70 connected to the in-vehicle adapter 83 does not include the proximity wireless interface 52 that provides proximity high-speed wireless communication, proximity high-speed wireless communication can be established between the mobile terminal 70 and the proximity wireless interface 21. Hence, the functions of an in-vehicle information terminal can be incorporated into the mobile terminal 70 that does not include the proximity wireless interface 52, which provides proximity high-speed wireless communication. Moreover, even if the mobile terminal 70 does not include the proximity wireless interface 52, which provides proximity high-speed wireless communication, the mobile terminal 70 is wirelessly connected to the in-vehicle apparatus 30. Therefore, no trouble is caused by a connection based on a physical contact.
The in-vehicle adapter 83 includes the wireless power receiving interface 53 that receives electrical power wirelessly supplied from the wireless power feed interface 22. Therefore, even if the mobile terminal 70 connected to the in-vehicle adapter 83 does not include the wireless power receiving interface 53, electrical power can be wirelessly supplied from the vehicle to the mobile terminal 70. Hence, the mobile terminal 70 without the wireless power receiving interface can also be steadily used as an in-vehicle information terminal.
The mounting position of the in-vehicle adapter 83 can be determined based on the positions of the proximity wireless interface 21 and the proximity wireless interface 52. Besides, the recessed portion 24 can be designed so as to use the same in-vehicle adapter 83 by rotating the in-vehicle adapter 83 with respect to the recessed portion 24 no matter what location in the vehicle the in-vehicle adapter 83 is disposed at.

### Alternative Embodiments

The present disclosure is not limited to the foregoing embodiments. The foregoing embodiments may be modified as described below.
If the mobile terminal 50, 70 is not shaped like a rectangular plate, the recessed portion 24 (in-vehicle adapter 23, 83) may have a circular cross section (may be shaped like a disk) or may be otherwise shaped to match the mobile terminal 50, 70 having a cross section other than a rectangular cross section (shaped like a rectangular plate). In such an instance, the proximity wireless interface 21 and the proximity wireless interface 52 can be disposed on at least one part of a circular rim. When the proximity wireless interface 21 and the proximity wireless interface 52 are disposed in the above manner, the position of the proximity wireless interface 21 can be adjusted to agree with the position of the proximity wireless interface 52 by rotating the mobile terminal 50 or the in-vehicle adapter 83.
The mobile terminal 70 may be connected to a mobile terminal adapter 83A having the same configuration as the in-vehicle adapter 83. The mobile terminal adapter 83A is shaped to be portable to be carried while being attached to the mobile terminal 70. More specifically, the mobile terminal adapter 83A is shaped like a casing for the mobile terminal 70. Consequently, even when the mobile terminal 70 is positioned outside the vehicle, proximity high-speed wireless communication can be established by attaching the mobile terminal adapter 83A to the mobile terminal 70.

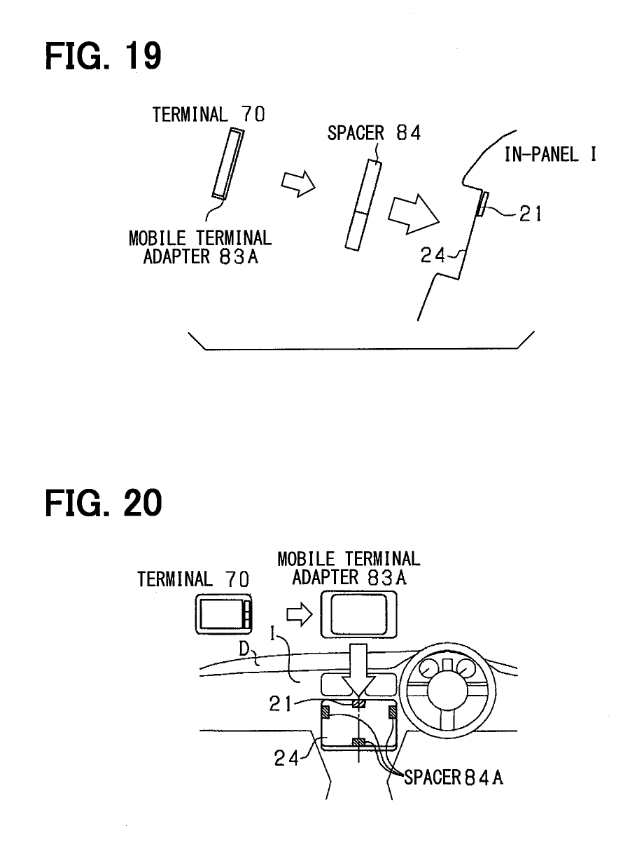

FIGS. 18 and 19 illustrate securing the mobile terminal 70, which is attached with the mobile terminal adapter 83A, to the instrument panel I for use. The recessed portion 24 having a rectangular cross section is formed on the instrument panel I. The proximity wireless interface 21 is disposed at the center of at least one side of the recessed portion 24 having a rectangular cross section. The user disposes a spacer 84 on the recessed portion 24 to fill the gap between the recessed portion 24 and the mobile terminal adapter 83A shaped like a rectangular plate. The spacer 84 is U-shaped so as to enclose three sides of the mobile terminal adapter 83A shaped like a rectangular plate. The user disposes the mobile terminal 70, which is attached to the mobile terminal adapter 83A, on the recessed portion 24 with the spacer 84 such that the position of the proximity wireless interface 21 disposed on the recessed portion 24 agrees with the position of the proximity wireless interface 52 built in the mobile terminal adapter 83A. That is, the retaining portion is formed by the recessed portion 24, the mobile terminal adapter 83A, and the spacer 84.

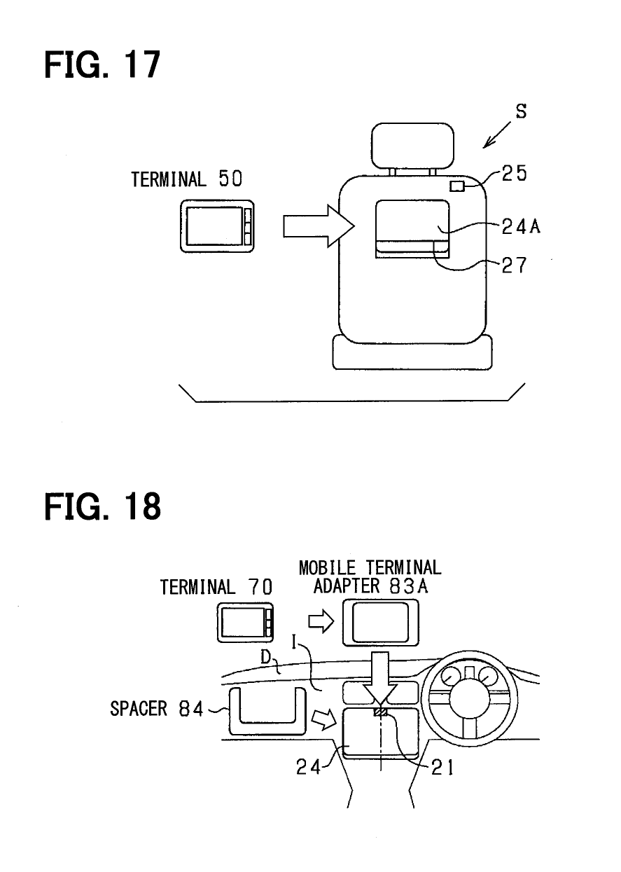

Alternatively, as in FIG. 20, the spacer may be formed of three spacers 84A that respectively support a part of one of three sides of the mobile terminal adapter 83A shaped like a rectangular plate. In this instance, the retaining portion is formed by the recessed portion 24, the mobile terminal adapter 83A, and the spacers 84A. The mounting position and size of each spacer 84A can be adjusted to suit the shape of the mobile terminal adapter 83A. Each spacer can be formed so as to support a part of at least one side of the mobile terminal adapter 83A. The spacers may be substituted by the in-vehicle adapter 23 that is shaped to match the shape of the mobile terminal adapter 83A. Even when the mobile terminal 70 attached to the mobile terminal adapter 83A is to be secured to the rear surface of at least either the driver seat or the front passenger seat, the mobile terminal 70 attached to the mobile terminal adapter 83A is disposed on the recessed portion 24 to which the spacer 84 (or a combination of the spacers 84A) is attached.
The proximity wireless interface 21 and the wireless power feed interface 22 may be incorporated into the in-vehicle apparatus 30.
The in-vehicle apparatus 30 may be without the wireless power feed interface 22. Further, the mobile terminal 50 may be without the wireless power receiving interface 53. Furthermore, the in-vehicle adapter 83 may be without the wireless power receiving interface 53. That is, the mobile terminal 50, 70 need not always be charged within the vehicle.
The communication assistance apparatus 20 may be without the in-vehicle adapter 23. When the driver uses the mobile terminal 50 as an in-vehicle information terminal, the mobile terminal 50 is directly retained by the recessed portion 24A that is formed on the instrument panel I and shaped to match the shape of the mobile terminal 50, as in FIG. 16. Further, when a passenger in the rear seat uses the mobile terminal 50 as an in-vehicle information terminal, the mobile terminal 50 is directly retained by the recessed portion 24A that is shaped to match the shape of the mobile terminal 50 and formed on the board 27, which is shaped like a rectangular plate and attached to the rear surface of the seat S, as in FIG. 17. The retaining portion of the communication assistance apparatus 20 may be formed of the recessed portion 24A only.
The brightness of the display 56 of the mobile terminal 50 may coordinate with an on/off operation of the headlights as described below. The CPU 10 of the in-vehicle apparatus 50 transmits illumination information about the headlights to the mobile terminal 50 through the communication assistance apparatus 20. Based on the received illumination information, the mobile terminal 50 makes the brightness of its display 56 lower when the headlights are illuminated than when the headlights are extinguished.
The image displayed on the mobile terminal 50 may be fixed as described below. The CPU 10 of the in-vehicle apparatus 30 transmits information indicating that the mobile terminal 50 is retained by the retaining portion, to the mobile terminal 50 through the communication assistance apparatus 20. Upon receiving such information through the communication assistance apparatus 20, the mobile terminal 50 fixes a displayed image so as not to rotate.
A rear-view taken from the vehicle may be automatically displayed on the mobile terminal 50 as described below. The CPU 10 of the in-vehicle apparatus 30 transmits the shift position of the vehicle's transmission to the mobile terminal 50 through the communication assistance apparatus 20. If the received shift position of the vehicle's transmission is reverse shift, the mobile terminal 50 displays a rear view taken from the vehicle.
An alternative is to incorporate either one of the indicator 25 and the notification portion 60. Another alternative is to incorporate neither of them.
The display 56 of the mobile terminal 50, 70 need not always coordinate with the level of illumination provided by the vehicle's headlights. The user may be allowed to manually adjust the brightness of the display 56.
The communication assistance apparatus 20, 80 may be disposed at any place within a vehicle compartment except the vehicle's instrument panel I, the dashboard D, and the rear surface of the seat S that is the driver seat or the front passenger seat.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication assistance apparatus that assists communication between a mobile terminal and an in-vehicle controller connected to various units including an in-vehicle camera of a vehicle, the communication assistance apparatus comprising:
a communication portion connected to the in-vehicle controller to
receive, from the mobile terminal by proximity high-speed wireless communication, data and
transmit, to the mobile terminal by proximity high-speed wireless communication, data from the in-vehicle controller; and
a retaining portion that is disposed in a vehicle compartment of the vehicle to retain the mobile terminal to establish proximity high-speed wireless communication between the communication portion and the mobile terminal,
wherein:
the data from the in-vehicle controller includes a captured image captured by the in-vehicle camera;
the communication portion transmits, by proximity high-speed wireless communication, the captured image to the mobile terminal retained in the retaining portion; and
the captured image transmitted to the mobile terminal is displayed in a screen of the mobile terminal retained in the retaining portion.

2. The communication assistance apparatus according to claim 1, further comprising:
a wireless power feed portion that is capable of wirelessly supplying electrical power to the mobile terminal retained by the retaining portion.

3. The communication assistance apparatus according to claim 1,
wherein:
the retaining portion is a recessed portion disposed at least either an instrument panel or a dashboard of the vehicle; and
the communication portion is disposed adjacent to the recessed portion.

4. The communication assistance apparatus according to claim 1,
wherein:
the retaining portion includes
an adapter that is shaped to match a shape of the mobile terminal, and
a recessed portion that is disposed on at least one of an instrument panel and a dashboard of the vehicle to retain the adapter; and
the communication portion is disposed adjacent to the recessed portion.

5. The communication assistance apparatus according to claim 1,
wherein:
the retaining portion is a recessed portion disposed on a rear surface of at least either a driver seat or a front passenger seat of the vehicle; and
the communication portion is disposed adjacent to the recessed portion.

6. The communication assistance apparatus according to claim 1,
wherein:
the retaining portion includes
an adapter that is shaped to match a shape of the mobile terminal, and
a recessed portion that is disposed on a rear surface of a seat that is at least either a driver seat and a front passenger seat of the vehicle to retain the adapter; and
the communication portion is disposed adjacent to the recessed portion.

7. The communication assistance apparatus according to claim 4,
wherein:
the adapter includes a mobile terminal communication portion that is connected to the mobile terminal,
receives, by proximity high-speed wireless communication, data transmitted from the communication portion, and
transmits, by proximity high-speed wireless communication, data received from the mobile terminal to the communication portion.

8. The communication assistance apparatus according to claim 4, further comprising:
a wireless power feed portion that is disposed in the vehicle compartment and capable of wirelessly supplying electrical power;
wherein the adapter includes a wireless power receiving portion that is connected to the mobile terminal to receive electrical power supplied from the wireless power feed portion.

9. The communication assistance apparatus according to claim 7,
wherein:
the recessed portion has a rectangular cross section;
the communication portion is disposed at a center of at least one side of a bottom surface of the recessed portion;
the adapter is shaped of a rectangular plate; and
the mobile terminal communication portion is disposed at a center of at least one side of the adapter.

10. The communication assistance apparatus according to claim 4,
wherein:
the adapter is removable from the recessed portion; and
the recessed portion from which the adapter is removed is able to be attached with a dedicated in-vehicle display.

11. The communication assistance apparatus according to claim 4,
wherein:
the adapter is removable from the recessed portion; and
the recessed portion from which the adapter is removed is able to be attached with a decorative panel.

12. The communication assistance apparatus according to claim 1,
wherein:
if a connection between the mobile terminal and the in-vehicle controller is not established by proximity high-speed wireless communication when the mobile terminal is retained by the retaining portion, that the connection is not established is notified with a notification apparatus.

13. The communication assistance apparatus according to claim 1,
wherein:
when a connection to the in-vehicle controller is established by proximity high-speed wireless communication, that the connection is established is notified with a notification portion.

14. A communication system comprising:
the communication assistance apparatus according to claim 1; and
the in-vehicle controller.

15. The communication system according to claim 14,
wherein:
the in-vehicle controller determines whether an application launched by the mobile terminal is authorized in a predefined manner;
if the application is authorized in the predefined manner, the in-vehicle controller permits the mobile terminal to manipulate the various units; and
if the application is not authorized in the predefined manner, the in-vehicle controller prohibits the mobile terminal from manipulating the various units.

16. The communication system according to claim 14, further comprising:
a storage portion,
wherein the in-vehicle controller causes the storage portion to record a total distance traveled by the vehicle.

17. The communication system according to claim 14,
wherein
the in-vehicle controller
transmits information that is at least either a total distance traveled by the vehicle or maintenance information to the mobile terminal through the communication assistance apparatus,
displays the transmitted information on the screen of the mobile terminal, and
uses the mobile terminal as a meter of the vehicle.

18. The communication system according to claim 14,
wherein
the in-vehicle controller
transmits settings in using an air conditioner of the vehicle to the mobile terminal through the communication assistance apparatus,
displays the transmitted settings on the screen of the mobile terminal, and
uses the mobile terminal as a control panel of the air conditioner.

19. The communication system according to claim 18,
wherein
the in-vehicle controller receives input information, which is input to the mobile terminal, through the communication assistance apparatus, and controls the air conditioner based on the received input information.

20. The communication system according to claim 14,
wherein
the in-vehicle controller transmits illumination information about lights of the vehicle to the mobile terminal through the communication assistance apparatus and changes a brightness of the screen of the mobile terminal.

21. The communication system according to claim 14,
wherein
the in-vehicle controller transmits information to the mobile terminal through the communication assistance apparatus, the information indicating that the mobile terminal is retained by the retaining portion, and inhibits an image displayed on the mobile terminal from rotating.

22. The communication system according to claim 14,
wherein:
the in-vehicle controller transmits a shift position of a vehicle's transmission to the mobile terminal through the communication assistance apparatus; and
if the shift position of the vehicle's transmission is in reverse position that causes the vehicle to back, the in-vehicle controller causes the mobile terminal to display a rear view taken from the vehicle.

23. The communication system according to claim 14,
wherein:
the communication system further includes the mobile terminal;
the in-vehicle controller transmits illumination information about lights of the vehicle to the mobile terminal through the communication assistance apparatus; and
based on the received illumination information, the mobile terminal lower a brightness of the screen of the mobile terminal when the headlight is illuminated than when the headlight is extinguished.

24. The communication system according to claim 14,
wherein:
the communication system further includes the mobile terminal;
the in-vehicle controller transmits information to the mobile terminal through the communication assistance apparatus, the information indicating that the mobile terminal is retained by the retaining portion; and
when receiving the information indicating that the mobile terminal is retained by the retaining portion, the mobile terminal inhibits an image displayed on the mobile terminal from rotating.

25. The communication system according to claim 14,
wherein:
the communication system further includes the mobile terminal;
the in-vehicle controller transmits a shift position of a vehicle's transmission to the mobile terminal through the communication assistance apparatus; and
based on the received shift position, if the shift position of the vehicle's transmission is in reverse position that causes the vehicle to back, the mobile terminal displays a rear view taken from the vehicle.
